(19) United States
(12) Patent Application Publication
(10) Pub. No.: US 2023/0377363 A1
(43) Pub. Date: Nov. 23, 2023

(54) MACHINE LEARNING BASED MULTIPAGE SCANNING

(71) Applicant: ADOBE INC., SAN JOSE, CA (US)

(72) Inventors: Tong SUN, San Ramon, CA (US); Nicholas Sergei REWKOWSKI, Greenbelt, MD (US); Nedim LIPKA, Campbell, CA (US); Jennifer Anne HEALEY, San Jose, CA (US); Curtis Michael WIGINGTON, San Jose, CA (US); Anshul MALIK, Delhi (IN)

(21) Appl. No.: 17/663,785

(22) Filed: May 17, 2022

(51) Int. Cl. G06V 30/41; G06V 40/10; G06T 7/13

(52) U.S. Cl. CPC G06V 30/41; G06V 40/107; G06T 7/13; G06T 2207/30176

(57) ABSTRACT

Systems and methods for machine learning based multipage scanning are provided. In one embodiment, one or more processing devices perform operations that include receiving a video stream that includes image frames that capture a plurality of pages of a document. The operations further include detection, via a machine learning model that is trained to infer events from the video stream detects, a new page event. Detection of the new page event indicates that a page of the plurality of pages available for scanning has changed from a first page to a second page. Based on the detection of the new page event, the one or more processing devices capture an image frame of the page from the video stream. In some embodiments, the machine learning model detects events based on a weighted use of video data, inertial data, audio samples, image depth information, image statistics and/or other information.

### BACKGROUND

Document scanning applications for handheld computing devices, such as smartphones and tablets, have become increasingly popular and incorporate advanced features such as automatic boundary detection, document clean up, and optical character recognition (OCR). Such scanning applications permit users to generate high quality digital copies of documents from any location, using a device that many users will already have conveniently available on their person. Moreover, digital copies of important documents can be produced and promptly stored, for example to a cloud data storage system, before they have a chance to be lost or damaged. These scanning technologies, for many users, eliminate the need for expensive and bulky traditional scanners.

### SUMMARY

The present disclosure is directed, in part, to improved systems and methods for multipage scanning using machine learning, substantially as shown and/or described in connection with at least one of the figures, and as set forth more completely in the claims.

Embodiments presented in this disclosure provide for, among other things, technical solutions to the problem of providing multipage scanning applications for handheld user devices. With the embodiments described herein, a handheld user device automatically scans multiple pages of a multipage document to produce a multipage document file, while the user continuously turn pages of the multipage document. The scanning application observes a live video stream and uses a machine learning model trained to classify image frames captured from the video stream as one of a set of specific events (e.g., new page events and page capture events). The machine learning model recognizes new page events that indicate when the user is turning to a new document page or has otherwise placed a new page within the view of a camera of the user device. The machine learning model also recognizes page capture events that indicate when an image frame from the video stream has an unobstructed sharp image. Based on alternating indications of new page events and page capture events from the machine learning model, the multipage scanning application captures image frames for each page of the multipage document from the video stream, as the user turns from one page to the next. In some embodiments, the multipage scanning application provides audible or visual feedback on the user device that informs the user when a page turn is detected and/or when a document page is captured. The machine learning model technology disclosed herein is further advantageous over prior approaches as the machine learning model is able to weigh and balance multiple sensor inputs to detect new page events and to determine when an image in an image frame is sufficiently still to capture. For example, in some embodiments, the machine learning model classifies image frames from the video stream as events based on a weighted use of video data, inertial data, audio samples, image depth information, image statistics and/or other information.

### BRIEF DESCRIPTION OF THE DRAWINGS

The embodiments presented in this disclosure are described in detail below with reference to the attached drawing figures, wherein:

FIG. 1 is a block diagram illustrating an operating environment, in accordance with embodiments of the present disclosure;

FIG. 2 is a block diagram illustrating an example multipage scanning environment, in accordance with embodiments of the present disclosure;

FIG. 3 is a diagram illustrating an example aspect of a multipage scanning process in accordance with embodiments of the present disclosure;

FIG. 4A is a diagram illustrating an example of event detection model operation in accordance with embodiments of the present disclosure;

FIG. 4B is a diagram illustrating another example of event detection model operation in accordance with embodiments of the present disclosure;

FIG. 5 is a flow chart illustrating an example method embodiment for multipage scanning in accordance with embodiments of the present disclosure;

FIG. 6 is a diagram illustrating a user interface for a multipage scanning application in accordance with embodiments of the present disclosure;

FIG. 7 is a diagram illustrating aspects of training for an event detection machine learning model in accordance with embodiments of the present disclosure;

FIG. 8 is a diagram illustrating aspects of training for an event detection machine learning model in accordance with embodiments of the present disclosure;

FIG. 9 is a flow chart illustrating an example method embodiment for training an event detection machine learning model in accordance with embodiments of the present disclosure;

FIG. 10 is a diagram illustrating an example computing environment in accordance with embodiments of the present disclosure; and

FIG. 11 is a diagram illustrating an example cloud based computing environment in accordance with embodiments of the present disclosure.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments can be utilized and that logical, mechanical and electrical changes can be made without departing from the scope of the present disclosure. The following detailed description is, therefore, not to be taken in a limiting sense. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

Current scanning applications for smart phones require time-consuming interactions between the user and the scanning application. For example, a current workflow might require a user to manually indicate to the application each time capturing a document page is desired, hold the handheld device steady and wait for the application to capture the page, turn the document to the next page, and then inform the application that there is another page to capture. This cycle is repeated for each page of the document that the user wishes to scan. While some existing scanning applications provide auto capture features that prompt the user to hold steady while the application automatically captures the document, this feature typically takes several seconds before capturing a page, and does not recognize when a new page is in view. As a result, the process of using the scanning application to capture multiple pages from a multipage document can be slow and tedious, and inefficient with respect to utilizing the computing resources of the user device as many computing cycles are inherently consumed waiting for user input.

Embodiments of the present disclosure address, among other things, the problems associated with scanning multiple pages from a multipage document using a handheld smart user device. With these embodiments, a user can continuously turn pages of the multipage document as a scanning application on the user device captures a video stream. The scanning application observes the live video stream to decide when a page is turned to reveal a new page, and to decide when is the right time to generate a scanned document page from an image frame. The scanning application provides audible or visual feedback that informs the user when they can advance to the next page.

In embodiments, a machine learning model (e.g., hosted on a portable user device) is trained to classify image frames captured from the video stream as one of a set of specific events. For example, the machine learning model recognizes when one or more image frames capture a new page event that indicates that a new page with new content is available for scanning. The machine learning model also identifies as a page capture event when an image frame has a sufficiently sharp and unobstructed image to save that frame as a scanned page. For two-sided scanning, the machine learning model can be trained to recognize different forms of page turning.

Advantageously, the machine learning model approach disclosed herein can weigh and balance multiple sensor inputs to detect new page events and page capture events. For example, in some embodiments, the machine learning model classifies image frames from the video stream as events, based on a weighted use of inertial data, audio samples, and/or image depth information, in addition to the captured image frames. In some embodiments, the machine learning model is able to recognize and classify image frames entirely using on-device resources, and can be trained as a low parameter model needing only minimal training data. For example, the use of document boundary detection and hand detection models in conjunction with the machine learning model substantially minimizes the amount of the training video data needed. The embodiments presented herein improved computing resource utilization as fewer computing cycles are consumed waiting for manual user input. Moreover, the overall time for the user device to complete the scanning task is improved through the technical innovation of applying a machine learning model to a video stream, because the classification of streams as events substantially eliminates manual user interactions with the scanning application at each page.

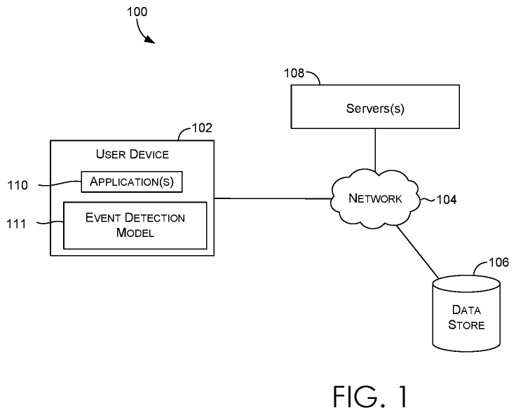

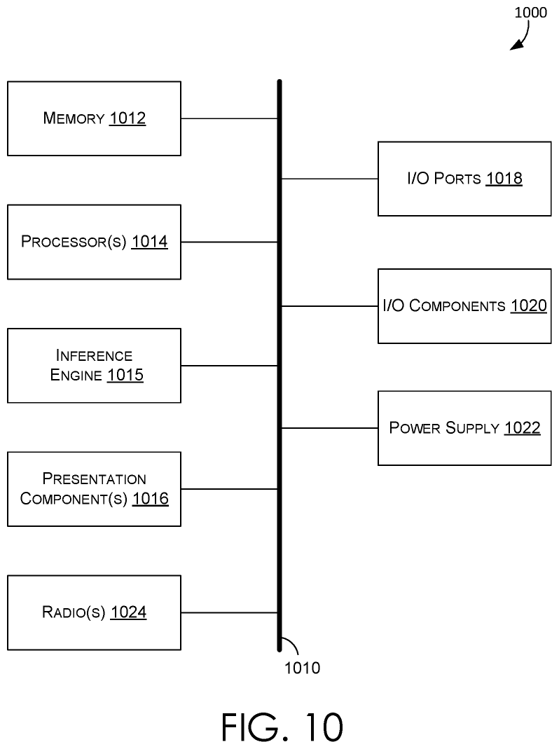

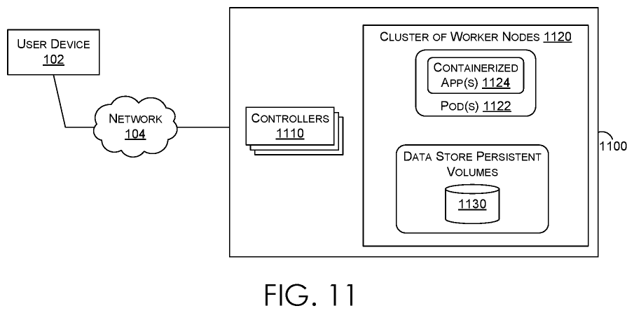

Turning to FIG. 1, FIG. 1 depicts an example configuration of an operating environment 100 in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that can be implemented as discrete or distributed components or in conjunction with other components, and in any suitable combination and location. Various functions described herein as being performed by one or more entities are be carried out by hardware, firmware, and/or software. For instance, in some embodiments, some functions are carried out by a processor executing instructions stored in memory as further described with reference to FIG. 10, or within a cloud computing environment as further described with respect to FIG. 11.

It should be understood that operating environment 100 shown in FIG. 1 is an example of one suitable operating environment. Among other components not shown, operating environment 100 includes a user device, such as user device 102, network 104, a data store 106, and one or more servers 108. Each of the components shown in FIG. 1 can be implemented via any type of computing device, such as one or more of computing device 1000 described in connection to FIG. 10, or within a cloud computing environment 1100 as further described with respect to FIG. 11, for example. These components communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) to provide wireless connectivity. Networking environments are commonplace in offices, enterprise-wide computer networks, intranets, and the Internet. Accordingly, network 104 is not described in significant detail.

It should be understood that any number of user devices, servers, and other components are employed within operating environment 100 within the scope of the present disclosure. Each component comprises a single device or multiple devices cooperating in a distributed environment.

User device 102 can be any type of computing device capable of being operated by a user. For example, in some implementations, user device 102 is the type of computing device described in relation to FIG. 10. By way of example and not limitation, a user device is embodied as a personal computer (PC), a laptop computer, a mobile device, a smartphone, a tablet computer, a smart watch, a wearable computer, a headset, an augmented reality device, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media includes computer-readable instructions executable by the one or more processors. The instructions are embodied by one or more applications, such as application 110 shown in FIG. 1. Application 110 is referred to as a single application for simplicity, but its functionality can be embodied by one or more applications in practice. As indicated above, the other user devices can include one or more applications similar to application 110.

The application 110 can generally be any application capable of facilitating the multi-page scanning techniques described herein, either on its own, or via an exchange of information between the user device 102 and the server 108. In some implementations, the application 110 comprises a web application, which can run in a web browser, and could be hosted at least partially on the server-side of environment 100. In addition, or instead, the application 110 can comprise a dedicated application, such as an application having image processing functionality. In some cases, the application is integrated into the operating system (e.g., as a service). It is therefore contemplated herein that “application” be interpreted broadly.

In accordance with embodiments herein, the application 110 comprises a page scanning application that facilitates scanning of consecutive pages from a multipage document. More specifically, the application takes as input a video stream of a multipage document using image frames from a video stream of the multipage document. The input video stream processed by the application 110 can be obtained from a camera of the user device 102, or may be obtained from other sources. For example, in some embodiments the input video stream is obtained from a memory of the user device 102, received from a data store 106, or obtained from server 108.

The application 110 operates in conjunction with a machine learning model referred to herein as the event detection model 111. The event detection model 111 generates event detection indications used by the application 110 to determine when a new page event occurs that indicates a new document page is available for scanning, and determine when to capture the new document page (i.e., a page capture event). Based on the detection of the new page event and the page capture event, the application 110 captures a sequence of image frames from the input video stream, the image frames each comprising a distinct scanned page of the multipage document. The sequence of scanned pages is then assembled into a multipage document file (such as an Adobe® Portable Document Format (.pdf) file, for example) that can be saved to a memory of the user device 102, and/or transmitted to the data store 106 or to the server 108 for storage, viewing, and/or further processing. In some embodiments, the event detection model 111 that generates the new page events and the page capture events is implemented on the user device 102, but in other embodiments is at least in part implemented on the server 108. In some embodiments, at least a portion of the sequence of scanned pages are sent to the server 108 by the application 110 for further processing (for example, to perform lighting or color correction, page straightening, and/or other image enhancements).

In one embodiment, in operation, a user of the user device 102 selects a multipage document (such as a book, a pamphlet, or an unbound stack of pages, for example) for scanning and places the multipage document into a field of view of a camera of the user device 101. The application 110 begins to capture a video stream of the multipage document and as the user turns pages of the multipage document. As the term is used herein “turn pages” or a “page turn” refers to the process of proceeding from one page of the multipage document to the next, and may include the act of the user physically lifting and turning a page, or in the case of 2-sided documents, changing the field of view of the camera from one page to the next (for example, shifting from a page on the left to a page on the right). The video stream is evaluated by the event detection model 111 to detect the occurrence of “events.” That is, based on evaluation of the video stream, the event detection model 111 is trained to recognize activities that it can classify as representing new page events or page capture events, and to generate an output comprising indications of when those events are detected.

The generation of a new page event indicated by the event detection model 111 informs the application 110 that a new document page of the multipage document has been placed within the field of view of the camera. That said, the new document page may not yet be ready for scanning. For example, the user's hand may still be obscuring part of the page, or there may still be substantial motion with respect to the page or of the user device 102, such that the contents of the new document page as they appear in the video stream are blurred. A page capture event is an indication by the event detection model 111 that the currently received frame(s) of the video stream comprise image(s) of the new document page that are acceptable for capture as a scanned page. Upon capturing the scanned page, the application 110 returns to monitoring for the next new page event indication from the event detection model 111 and/or for an input from the user indicating that scanning of the multipage document is complete.

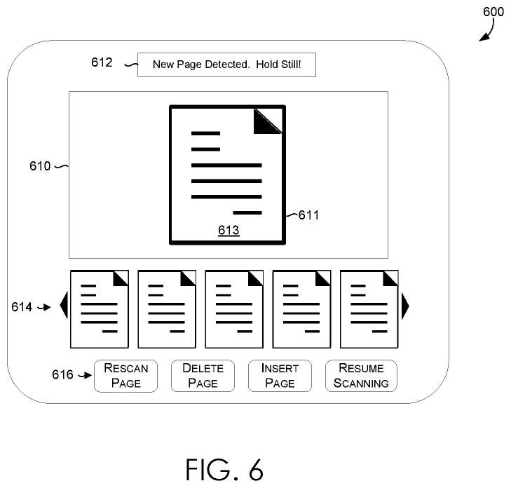

In some embodiments, the application 110 provides a visual output (e.g. such as a screen flash) or audible output (e.g., such as a shutter click sound) to the user that indicates when a document page has been scanned to prompt the user to turn to the next document page. The application 110, in some embodiments, also provides an interactive display on the user device 102 that allows the user to view the document page as scanned, and select a document page for rescanning if the user is not satisfied with the document page as scanned. Such a user interface is discussed below in more detail with respect to FIG. 6. Once a user indicates that scanning of the multipage document is complete, the application 110 generates the multipage document file that can be saved to a memory of the user device 102, and/or transmitted to the data store 106, or to the server 108 for storage, viewing, or further processing. In some embodiments, the application 110 permits the user to pause the scanning process and store an incomplete scanning job, which the user can resume at a later point in time without loss of progress.

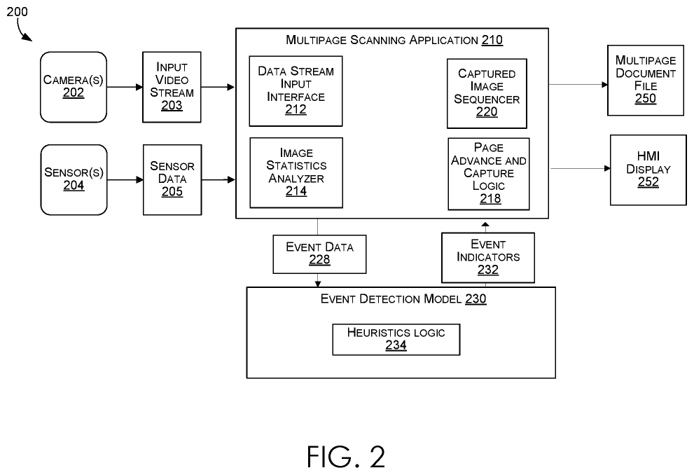

FIG. 2 is a diagram illustrating an example embodiment of a multipage scanning environment 200 comprising an multipage scanning application 210 (such as application 110 shown in of FIG. 1) and an event detection model 230 (such as the event detection model 111 of FIG. 1). Although they are shown as separate elements in FIG. 2, in some embodiments, the multipage scanning application 210 includes the event detection model 230. While in some embodiments the multipage scanning application 210 and event detection model 230 are implemented entirely on the user device 102, in other embodiments, one or more aspects of the multipage scanning application 210 and/or the event detection model 230 are implemented by the server 108 or distributed between the user device 102 and server 108. For such embodiments, server 108 includes one or more processors, and one or more computer-readable media that includes computer-readable instructions executable by the one or more processors.

In some embodiments (as more particularly described in FIGS. 10 and 11), the multipage scanning application 210 is implemented by a processor 1014 (such as a central processing unit), or controller 1110 implementing a processor, that is programed with code to execute one or more of the functions of the multipage scanning application 210. The multipage scanning application 210 can be a sub-component of another application. The event detection model 230 can be implemented by a neural network, such as a deep neural network (DNN), executed on an inference engine. In some embodiments, the event detection model 230 is executed on an inference engine/machine learning coprocessor 1015 coupled to processor 1014 or controller 1110, such as but not limited to a graphics processing unit (GPU).

In the embodiment shown in FIG. 2, the multipage scanning application 210 comprises one or more of a data stream input interface 212, an image statistics analyzer 214, a page advance and capture logic 218 and a captured image sequencer 220. The data stream input interface 212 receives the input video stream 203 (e.g., a digital image(s)) from a camera 202 (for example, one or more digital cameras of the user device 102) or other video image source. In other embodiments, a video image source comprises a data store (such as data store 106) that stores previously captured video as files.

In the embodiment of FIG. 2, the input video stream 203 is received by the multipage scanning application 210 via the data stream input interface 212. A stream of image frames based on the input video stream 203 is passed to the event detection model 230 as event data 228. In some embodiments, the event data 228 comprises the input video stream 203 as-received by the data stream input interface 212. In other embodiments, multipage scanning application 210 derives the event data 228 from the input video stream 203. For example, the event data 228 may comprise a version of the original input video stream 203 having an adjusted (e.g., reduced) frame rate compared to the frame rate of the original input video stream 203. In some embodiments, data stream input interface 212 also optionally receives sensor data 205 produced by one or more other device sensors 204. In such embodiments, the event data 228 further comprises the sensor data 205, or other data derived from the sensor data 205 (for example, an image histogram generated by the image statistics analyzer 214 as further explained below). In some embodiments, the event data 228 is structured as frames of data where sensor data 205 and image frames from the video stream 203 are synchronized in time.

The event data 228 is passed by the multipage scanning application 210 to the event detection model 230, from which the event detection model 230 generates event indicators 232 (e.g., the new page event and the page capture event indicators) used by the multipage scanning application 210. In some embodiments, for each video image frame of the event data 228, the event detection model 230 evaluates whether the image frame represents a new page event or a page capture event, and computes respective confidence values based on those determinations.

For example, in some embodiments, the event detection model 230 outputs a new page event based on computations of a first confidence value. The first confidence value represents the level of confidence the event detection model 230 has that an image frame depicts a page turning event from one document page to a next document page. In some embodiments, the confidence value is represented in terms of a scale from a low confidence level of a page turning event (e.g., 0% confidence) to a high confidence level of a page turning event (e.g., 100% confidence). A low confidence value for a new page event would indicate that the event detection model 230 has a very low confidence that the image frame depicts a new page event, while a high confidence value for a new page event would indicate that the event detection model 230 has a very high confidence that the image frame depicts a new page event.

In some embodiments, the event detection model 230 applies one or more thresholds in determining when to output a new page event indication to the page advance and capture logic 218 of the multipage scanning application 210. For example, the event detection model 230 can define an image frame as representing a new page event based on the confidence value for a new page event exceeding a trigger threshold (such as a confidence value of 80% or greater, for example). When the confidence value meets or exceeds the trigger threshold, the event detection model 230 outputs the new page event to the page advance and capture logic 218. The page advance and capture logic 218, in response to receiving the new page event, monitors for receipt of a page capture event in preparation for capturing a new document page from the input video stream 203. In some embodiments, the page advance and capture logic 218 increments a page count index in response to the new page event exceeding the trigger threshold, and the next new document page that is saved as a scanned page is allocated a page number based on the page count index.

In some embodiments, the event detection model 230 also applies a reset threshold in determining when to output a new page event indication. Once the event detection model 230 generates the new page event indication, the event detection model 230 will wait until the confidence value drops below the reset threshold (such as a confidence value of 20% or less, for example) before again generating a new page event indication. For example, if after generating a new page event indication the confidence value drops below the trigger threshold but not below the reset threshold, and then again rises above the trigger threshold a second time, event detection model 230 will not trigger another new page event indication because the confidence value did not first drop below the reset threshold. The reset threshold thus ensures that a page turn by the user is completed before generating another new page event.

Similarly, in some embodiments, the event detection model 230 outputs a page capture event based on a second confidence value. This second confidence value represents the level of confidence the event detection model 230 has that an image frame from the event data 228 depicts a stable and unobstructed image of a new document page acceptable for scanning. In some embodiments, the confidence value is represented in terms of a scale from a low confidence level (e.g., 0% confidence) to a high confidence level (e.g., 100% confidence). For example, a low confidence value page capture event would indicate that the event detection model 230 has a very low confidence that the image frame depicts a new document page in a proper state for capturing, while a high confidence value new page event would indicate that the event detection model 230 has a very high confidence that the new document page is in a proper state for capturing.

In some embodiments, the event detection model 230 applies one or more thresholds in determining when to output a page capture event indication to the page advance and capture logic 218. For example, the event detection model 230 can define an image frame as depicting a document page in a proper state for capturing based on the confidence value of a new page event exceeding a capture threshold (such as a confidence value of 80% or greater, for example). When the confidence value meets or exceeds the capture threshold, the event detection model 230 outputs the page capture event to the page advance and capture logic 218.

The page advance and capture logic 218, in response to receiving the page capture event, captures an image frame based on the video stream 203 as a scanned page for inclusion in the multipage document file 250. In some embodiments, the multipage scanning application 210 applies a document boundary detection model or similar algorithm to the captured image frame so that the scanned page added to the multipage document file comprises an extraction of the document page from the image frame, omitting any background outside of the boundaries of the document page. Once the new document page is scanned and added to the multipage document file 250, the page advance and capture logic 218 will no longer respond to page capture event indications from the event detection model 230 until it once again receives a new page event indication.

In some embodiments, a captured image sequencer 220 operates to compile a plurality of the scanned pages into a sequence of scanned pages for generating the multipage document file 250 and/or displaying the sequence of scanned pages to a user of the user device 102 via a human-machine interface (HMI) 252. Further, in some embodiments where a captured image frame comprises multiple page images (such as when a single image frame captures both the left and right pages of a book laid open), the captured image sequencer 220 splits that image into component left and right pages and adds them in correct sequence to the sequence of scanned pages for multipage document file 250.

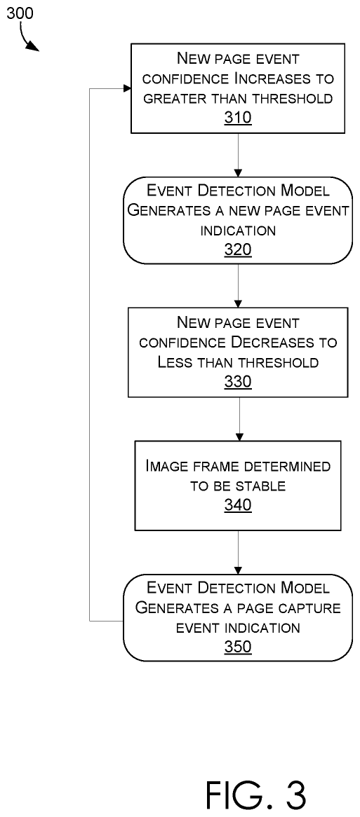

FIG. 3 generally at 300 illustrates an example scanning process flow according to one embodiment, as performed by the event detection model 230 while processing received event data 228. At 310, as a user begins to turn to a new page of the document, the event detection model 230 evaluates the event data 228 and computes a new page event confidence value that increase as the event data 228 more clearly indicates that the user is turning to a new page. When the new page event confidence value exceeds a threshold, the event detection model 230 outputs a new page event indication (shown at 320). When the user completes the turn to the new page, the new page event confidence value will accordingly decrease based on the event data 228 (which no longer indicates that the user is turning to a new page), and as shown at 330, eventually drop below a reset value. The generation of the new page event indication informs the multipage scanning application 210 that the page available for scanning has changed from a first (previous) page to a second (new) page so that once the image frame of the new page is determined to be sufficiently stabilized (at 340), a frame from the input video stream 203 can be captured. In some embodiments, based on the event data 228 the event detection model 230 computes a page capture event confidence value that indicates, for example, that an unobstructed and stable image of the new document page is in the camera field of view. When the page capture event confidence value is greater than a capture threshold, the event detection model 230 outputs a page capture event indication (shown at 350). The event detection model 230 then returns to 310 to look for the next page turn based on received event data 228.

In some embodiments, in order to avoid missing the opportunity to capture a high quality image frame after a page turn, the multipage scanning application 210 begins capturing image frames after receiving the new page event indication while monitoring the page capture event confidence value generated by the event detection model 230. When the multipage scanning application 210 detects a peak in the page capture event confidence value, the image frame corresponding to that peak is used as the captured (scanned) document page. In some embodiments, when the page capture event confidence value does not at least meet a capture threshold, the multipage scanning application 210 may notify the user so that the user can go back and attempt to rescan the page. Likewise, when the multipage scanning application 210 does capture and image frame corresponding to a page capture event confidence value that does exceed the capture threshold, the multipage scanning application 210 may prompt the user to move on to the next page.

Returning to FIG. 2, as previously mentioned, in some embodiments, the event data 228 evaluated by the event detection model 230 may further include (in addition to video data) sensor data 205 generated by one or more sensors 204, and/or data derived therefrom. Such sensor data 205 may include, but is not limited to, audio data, image depth data, and inertial data.

In some embodiments, sensor data 205 comprises audio data captured by one or more microphones of the user device 102. When a multipage document is physically manipulated by a user to turn from one page of the document to another, the manipulation of the page produces a distinct sound. For example, when turning a page, crinkling of the paper and/or the sound of pages rubbing against each other produces a spike in noise levels within mid-to-low frequencies with an audio signature that can be correlated to page turning. In some embodiments, the multipage scanning application 210 inputs sample of sounds captured by a microphone of the user device 102 and feeds those audio samples to the event detection model 230 as a component of the event data 228. The event detection model 230 in such embodiments is trained to recognize and classify the noise produced from turning pages as new page events, and may weigh inferences from that audio data with inferences from the video data for improved detection of a new page event. For example, the event detection model 230 may compute a higher confidence value for a new page event when video image data and audio image data both indicate that the user has turned to a new document page.

In some embodiments, sensor data 205 further comprises image depth data captured by one or more depth perception sensors of the user device 102. For example, the image depth data can be captured from LiDAR sensors or proximity sensors, or computed by the multipage scanning application 210 from a set of two or more camera images. In some embodiments, user device 102 may comprise an array having multiple cameras and approximated image depth data is computed from images captured from the multiple cameras. In some embodiments, user device 102 includes one or more functions, such as functions based on augmented reality (AR) technologies, that merge multiple images frames together to compute the image depth data as a function of parallax. The detection of a significant and/or sudden change in page depth, for example where an edge of a document page is detected as rapidly moving closer to the depth perception sensor and then falling away, is an indication that the user has turned a page that can also we weighed with information from the video data for improved detection of a new page event. For example, the event detection model 230 may compute a higher confidence value for a new page event when video image data and image data both indicate that the user has turned to a new document page.

In some embodiments, sensor data 205 further comprises inertial data captured by one or more inertial sensors (such as accelerometers or gyroscopes, for example) of the user device 102. For example, inertial data captures motion of the user device 102 such as when the user causes the user device 102 to move while turning a document page. Moreover, inertial data may be particularly useful to detect page turning events that do not necessarily comprise physical manipulation of a document page. For example, for scanning two-sided document pages (such as for a book laid open), event detection model 230 may infer a new page event based on detecting motion of the user device 102 shifting from left to right in combination with image data capturing motion of the user device 102 from left to right. The event detection model 230 may compute a higher confidence value for a new page event when video image data and inertial data both indicate that the user has turned to a new document page. Likewise, in some embodiments, the event detection model 230 uses a stillness of the user device 102 as indicated from the inertial data in conjunction with video image data to infer that a page capture event indication should be generated.

It should be noted that in some embodiments, event detection model 230 and/or multipage scanning application 210 are configurable to account and adjust for cultural and/or regional differences in the layout of printed materials. For example, new page event detection by the event detection model 230 can be configured for documents formatted to be read to left-to-right, from right-to-left, with left-edge bindings, with right edge bindings, with top or bottom edge bindings, or for other non-standard document pages such as document pages that include fold-out leafs or multi-fold pamphlets, for example.

In some embodiments, the multipage scanning application 210 and/or other components of the user device 102 compute data derived from the video stream 203 and/or sensor data 205 for inclusion in the event data 228. For example, in some embodiments, the event data includes image statistics (such as an image histogram) for the input video stream 203 that is computed by the multipage scanning application 210 and/or other components of the user device 102. Dynamically changing image statistics from the video data is information the event detection model 230 may weigh in conjunction with other event data 228 to infer either that a new page capture event or page capture event indication should be generated. For example, the event detection model 230 computes a higher confidence value for a new page event when video image data and image statistics data both indicate that the user has turned to a new document page. Similarly, the event detection model 230 computes a higher confidence value for a page capture event when video image data and image statistics data both indicate that the new document page is still and unobstructed.

The event detection model 230, in some embodiments, is trained to weigh each of a plurality of different data components comprised in the event data 228 in determining when to generate a new page event indication and a page capture event indication, such as, but not limited to the video stream data, audio data, image depth data, inertial data, image statistics data and/or other data from other sensors of the user device. Moreover, the event detection model 230, in some embodiments, is trained to dynamically adjust the weighting assigned to each of the plurality of different data components comprises in the event data 228. For example, the event detection model 230 can decrease the weight applied to audio data when the ambient noise in a room renders audio data unusable, or when the user has muted the microphone sensor of the user device 102.

The event detection model 230 also, in some embodiments, uses heuristics logic (shown at 234) to simplify decision-making. That is, when at least one of the components of event data 228 results in a substantial confidence value (e.g., in excess of a predetermined threshold) for either a new page event or page capture event, even without further substantiation from other components of event data 228, then the event detection model 230 proceeds to generate the corresponding new page event indication or page capture event indication. In some embodiments, heuristics logic 234 instead functions to block generation of a new page event or page capture event indications. For example, if inertial data indicates that the camera 202 of the user device 102 is no longer facing in the direction of the document being scanned (e.g., not pointed downward), then the heuristics logic 234 will block the event detection model 230 from generating either new page event or page capture event indications regardless of what video, audio, image depth, inertial, and/or other data is received in the even data 228. As an example, if the user raises the user device 102 and inadvertently directs the camera 202 at a wall, notice board, display screen projection, or other object that could potentially appear to be a document page, the event detection model 230, based on the heuristics logic 234 processing of the inertial data, will understand that the user device 102 is oriented away from the document, and that any perceived document pages are not pages of the document being scanned. The event detection model 230 therefore will not generate either new page event or page capture events based on those non-relevant observed images.

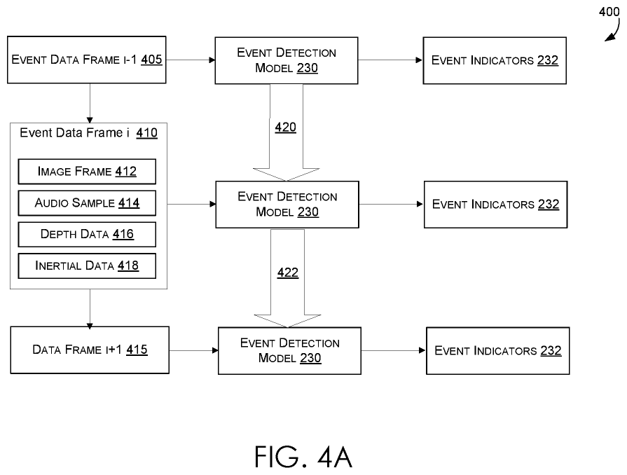

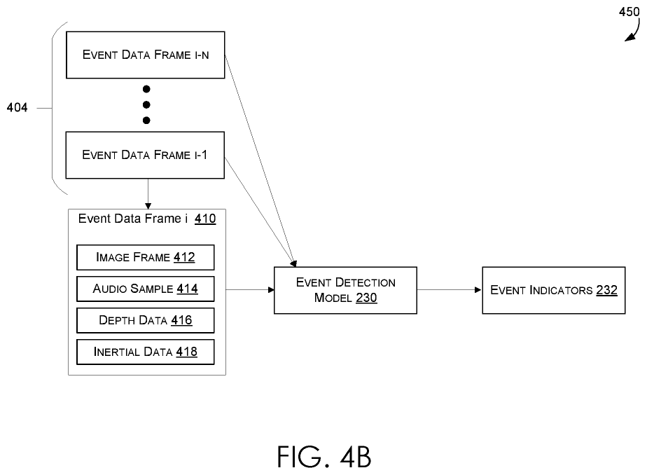

FIG. 4A is a diagram illustrating at 400 operation of the event detection model 230 according to an example embodiment. In the embodiment shown in FIG. 4A, the event detection model 230 inputs data frame “i” (shown at 410) of event data 228 that comprises an image frame 412 derived from the video stream 203. Each data frame 410 in this example embodiment comprising image frame 412, an audio sample 414, depth data 416 and/or inertial data 418. The event detection model 230 inputs the data frame i (410) and when a new page event or page capture event are detected, generates an event indicator 232. In this embodiment, the event detection model 230 is implemented using a recurrent neural network (RNN) architecture that for each processing step takes latent machine learning data (e.g., a vector of flow values determined by the event detection model 230) from a previous processing step, and passes latent machine learning data computed at the current processing step for use in the next processing step. In the example of FIG. 4, the event detection model 230 inputs latent machine learning data (shown at 420) computed during the prior data frame “i-1” (405) and weighs that information together with the data from the current data frame i (410) in determining whether to classify the current data frame i (410) as either a new page event or a page capture event. Likewise, to evaluate the next data frame “i+1” (shown at 415), the event detection model 230 passes on latent machine learning data (shown at 422) computed from data frame “i” (410) to determine whether to classify the next data frame i+1 (415) as either a new page event or a page capture event. In some embodiments, the event detection model 230 comprises a Long Short-Term Memory (LSTM) recurrent neural network, or other recurrent neural network. In some embodiments, the event detection model 230 is optionally a bidirectional model (e.g., where the latent machine learning data flows at 420, 422 are bidirectional), which infers event at least in part based on features or clues present in a subsequent frame.

FIG. 4B is a diagram illustrating an alternate configuration 450 for operation of the event detection model 230 according to an example embodiment. In this embodiment, as with the embodiment of FIG. 4A, the event detection model 230 inputs the data frame “i” (shown at 410) of event data 228 and when a new page event or page capture event are detected, generates an event indicator 232. In this embodiment, in contrast to that of FIG. 4A, the event detection model 230 inputs one or more prior data frames (shown at 404) in addition to the current data frame i 410 to determine whether to classify the current data frame i 410 as either a new page event or a page capture event. That is, the event detection model 230 considers the information from a least one prior data frame 404 rather than receiving latent machine learning data 420 from a prior processing iteration.

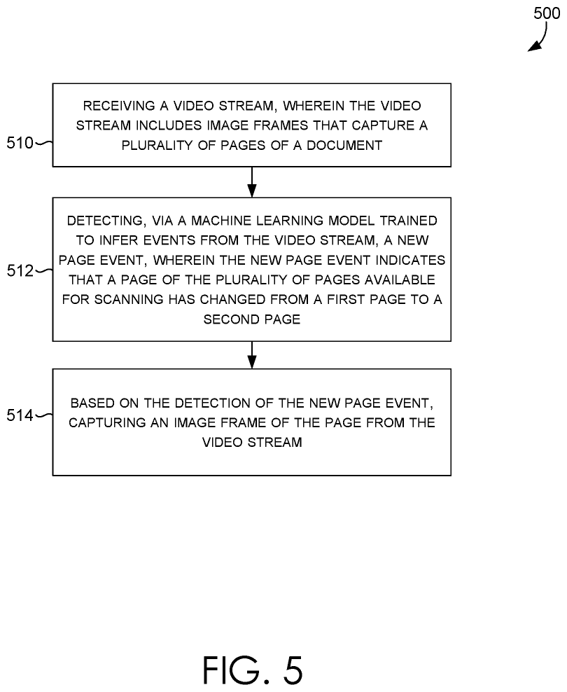

To illustrate an example process implemented by the multipage scanning environment 200, FIG. 5 comprises a flow chart illustrating a method 500 for implementing a multipage scanning application. It should be understood that the features and elements described herein with respect to the method 500 of FIG. 5 can be used in conjunction with, in combination with, or substituted for elements of, any of the other embodiments discussed herein and vice versa. Further, it should be understood that the functions, structures, and other descriptions of elements for embodiments described in FIG. 5 can apply to like or similarly named or described elements across any of the figures and/or embodiments described herein and vice versa. In some embodiments, elements of method 500 are implemented utilizing the multipage scanning environment 200 comprising multipage scanning application 210 and event detection model 230 disclosed above, or other processing device implementing the present disclosure.

Method 500 begins at 510 with receiving a video image stream, wherein the video image stream includes image frames that capture a plurality of pages of a document. In some embodiments, the video image stream is a live video stream as-received from a camera or comprises image frames that are derived from a live video stream as-received from a camera. For example, the received video image stream, in some embodiments, comprises a version of an original video stream, for example having an adjusted frame rate or other alteration relative to the original video stream.

Method 500 at 512 includes detecting, via a machine learning model trained to infer events from the video image stream, a new page event. Detection by the machine learning model of a new page event indicates that a new document page is available for scanning (e.g., that a page of the plurality of pages available for scanning has changed from a first page to a second page). In some embodiments, the machine learning model trained may optionally further detect a page capture event. Detection of a page capture event indicates that an image from the image frames comprises a stable image of the new page and thus indicates when to capture the new document page. In some embodiments, the method comprises detecting of the new page event with the machine learning model, and determination of image stability (or otherwise when to perform a page capture) is determined in other ways (e.g., using inertial sensor data).

In some embodiments, the machine learning model also optionally receives sensor data produced by one or more other device sensors, or other data derived from the sensor data (for example, such as an image histogram computed by image statistics analyzer 214). In some embodiments, the event detection model is trained to weigh each of a plurality of different data components comprises in detecting a new page event or a page capture event, such as, but not limited to the video stream data, audio data, image depth data, inertial data, image statistics data and/or other data from other sensors of the user device. Moreover, the event detection model, in some embodiments, is trained to dynamically adjust the weighting assigned to each of the plurality of different data components comprises in the event data. For example, the event detection model can decrease the weight applied to audio data when the ambient noise in a room renders audio data unusable, or when the user has muted the microphone sensor of the user equipment. The event detection model also, in some embodiments, uses heuristics logic to simplify decision-making, as discussed above.

Method 500 at 514 includes, based on the detection of the new page event, capturing an image frame of the new document page from the video image stream. In some embodiments, the multipage scanning application applies a document boundary detection model or similar algorithm to the captured image frame so that the scanned page added to the multipage document file comprises an extraction of the document page from the image frame, omitting any background outside of the boundaries of the document page. In some embodiments, the multipage scanning application, in response to receiving the new page event from the machine learning model, optionally monitors for receipt of an indication of a page capture event in preparation for capturing a new document page from the video image stream. The multipage scanning application, in response to receiving an indication of a page capture event, captures an image frame based on the video image stream as a scanned page for inclusion in the multipage document file. Once the new document page is scanned and added to the multipage document file, in some embodiments, the multipage scanning application will no longer respond to page capture event indications from the machine learning model until it once again receives a new page event indication.

In some embodiments, the machine learning model delays output of a new page event or a page capture event to provide additional time to build confidence with respect to the detection of a new page event and/or page capture event. That is, by delaying output of event indications, in some embodiments the machine learning model can base detection on a greater number of frames of data.

FIG. 6 is a diagram illustrating an example user interface 600 generated by the multipage scanning application 210 on the HMI display 252 of the user device 102. At 610, the user interface 600 presents a live display of the input video stream 203 received by the multipage scanning application 210. At 612, the user interface 600 presents a dialog box that provides instructions and/or feedback to the user. As one example, the multipage scanning application 210 displays messages in dialog box 612 directing the user to hold steady, an indication when a page turn is detected, and/or an indication when scanned page is captured. In some embodiments, the user interface 600 may also overlay a bounding box 611 onto the live video stream display 610 indicating the detected boundaries of the document page 613.

In some embodiments, the user interface 600 provides a display of one or more of the most recently captured document page scans (shown at 614). In some embodiments, the user may select (e.g., by touching) the field displaying previously captured document page scans and scroll left or/or right to view previously captured document page scans. In some embodiments, the user may select a specific previously captured page scan to view an enlarged image, and/or indicate via one or more controls (shown at 616) provided on the user interface 600 to insert, delete and/or retake a previously captured page scan. The multipage scanning application 210 would then prompt the user (e.g., via dialog box 612) to locate the document page of the physical document that is to be rescanned, and guide the user to place that page in the field of view of the camera so that a new image of the page can be captured. In some embodiments, the captured image sequencer 220 will collate the rescanned document page into the sequence of scanned pages, taking the place of the deleted page. In the same manner, the user can indicate via the controls 616 to insert a page between previously scanned document pages, and the captured image sequencer 220 will collate the new scanned document page into the sequence of scanned pages. Via the one or more controls 616, the user can also instruct the multipage scanning application 210 to resume multipage scanning at the point where multipoint scanning was previously paused.

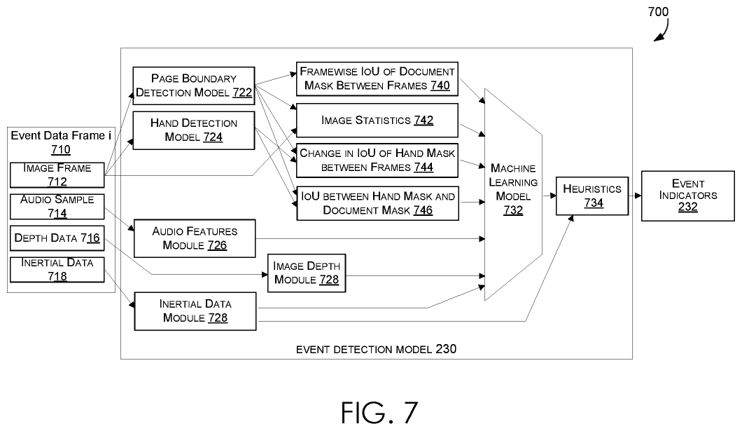

FIG. 7 is a diagram illustrating at 700 aspects of training an event detection model, such as event detection model 230 of FIG. 2, in accordance with one embodiment. Training of the event detection model 230 as implemented by the process illustrated in FIG. 7 is simplified and has a significantly reduced data collection burden (as compared to traditional machine learning training) because the technique leverages the use of existing models trained for other tasks, particularly a page boundary detection model 722 and a hand detection model 724. Event detection model 230 also comprises multiple modules, including an audio features module 726, an image depth module 728 and an inertial data module 730, in addition to modules comprising the page boundary detection model 722 and the hand detection model 724. Each of these modules feed into a low parameter machine learning model 732 (such as an LSTM for example). The training data frame 710 for this example comprises the same elements as data frame 710, and includes an image frame 712, audio sample 714, depth data 716 and inertial data 718. As previously explained, a data frame 710 input to an event detection model 230 can comprise these and/or other forms of measurements and information indicative of new page events and page capture events. As such, the example training data frame 710 is not intended as a limiting example as other forms of measurements and information indicative of new page events and page capture events may be used together with, or in place of, the forms of measurements and information shown in training data frame 710.

Referring to FIG. 7, the page boundary detection model 722 receives and processes the image frame 712 information from the training data frame 710. The page boundary detection model 722 is a previously trained model that automatically finds the corners and edges of a document, and determines a bounding box (i.e., a document page mask) around a document appearing in the image frame 712. The page boundary detection model 722 operates as a segmentation model that predicts which pixels of the image frame 712 belong to the background and which pixel of the image frame 712 belong to the document page. A page boundary detection model 722 runs efficiently in real time on a standard handheld computing device, such as user device 102, and advantageously alleviates a need to train the machine learning model 732 to infer page boundaries directly.

In some embodiment, the event detection model 230 applies a “Framewise Intersection over Union (IoU) of Document Mask between Frames” evaluation (shown at 740) to images within the page boundaries (i.e., the document page mask) detected by the page boundary detection model 722, and computes an IoU between images of two data frames 710. An IoU computation provides a measurement of overlap between two regions (such as between regions of bounded pages images page), generally in terms of a percentage indicating a how similar they are. When there is minimal motion of the document page between the two data frames 710, the Framewise IoU of Document Mask between Frames outputs a high percentage value indicating that the two data frames are very similar, whereas motion, and changes and/or warping of a page between the two data frames 710 will cause the Framewise IoU of Document Mask between Frames to output a low percentage value. As shown in FIG. 7, the output of the Framewise IoU of Document Mask between Frames is fed to the machine learning model 732 as an input for training the machine learning model 732.

In some embodiment, the event detection model 230 applies image statistics 742 to images from a data frames 710 within the document page mask detected by the page boundary detection model 722 and provides the computed image statistics to the machine learning model 732 as an input for training the machine learning model 732.

In some embodiments, the image statistics 742 computes a measurement of a change in document histogram between two data frames 710. Using the document page mask detected by the page boundary detection model 722, image statistics 742 computes a histogram for each document page. When there is relatively little difference between histograms between document pages, that is usually an indication that the document page is steady, which is a reliable indication that the document page is not in the process of being turned by the user, and a positive indication that the document page is sufficiently stable for a page capture event.

In some embodiments, the image statistics 742 computes a measurement of a skewness of the document boundary in the document page mask detected by the page boundary detection model 722. For example, unless the plane of the user device 102 is perfectly aligned with the document being scanned, the existence of a camera angle often results in the corners of the document page mask having angles other than ideal 90 degree angles. A skewness measurement indicates an average distance from the deal 90 degree angle and usually increase when the user performs a page turn.

The hand detection model 724 also inputs the image frame 712 information from the training data frame 710. The hand detection model 724 is a previously trained model that infers the position and movement of a human hand appearing in the image frame 712. In some embodiments, the hand detection model 724 comprises a hand mask detection model. Knowledge of when user's hand is in the image frame 712, whether it is over the document page, and/or whether it is in motion, are each useful features that can be recognized by the hand detection model 724 for determining when a document page is being turned. In at least one embodiment, the hand detection model 724 comprises Mediapipe open-source hand detection models, or other available hand detection model. A hand detection model 724 runs efficiently in real time on a handheld computing user device 102, and also advantageously alleviates a need to train the machine learning model 732 to recognize hands directly. In some embodiments, the functions of the page boundary detection model 722 and hand detection model 724 are combined in a single machine learning model. For example, the page boundary detection model 722 further comprises a separate output layer and is trained to detect a hand and/or hand mask. In that case, a data set of hand images is added to the existing boundary detection dataset to that a single model learns both tasks.

In some embodiment, the event detection model 230 applies a “Change in IoU of Hand Mask between Frames” evaluation (shown at 744) to images within the document page mask detected by the page boundary detection model 722, and computes this IoU between hand and/or hand mask images of two data frames 710. When there is minimal motion of the hand mask between the two data frames 710, the Framewise IoU of Hand Mask between Frames outputs a high percentage value indicating that the position of any hand mask appearing in the two data frames are very similar, whereas motion and changes to the hand mask between the two data frames 710 will cause the Framewise IoU of Hand Mask between Frames to output a low percentage value. As shown in FIG. 7, the output of the Framewise IoU of Hand Mask between Frames is fed to the machine learning model 732 as an input for training the machine learning model 732.

In some embodiment, the event detection model 230 applies an “IoU between Hand Mask and Document Mask” evaluation (shown at 746) to images within the document page mask detected by the page boundary detection model 722. This evaluation computes a measurement indicating how much the hand mask computed by the hand detection model 724 overlaps with the document page mask computed by the boundary detection model 722. When the user is performing a page turn, the hand mask is likely to at least partially overlap the document page map. As shown in FIG. 7, the output of the IoU between Hand Mask and Document Mask is fed to the machine learning model 732 as an input for training the machine learning model 732.

It should be understood that during training, the machine learning model 732 will learn to recognize new page events and page capture events from the image data based on combinations of these various detected image features. For example, during a page turn by the user, the machine learning model 732 can considers the combination of factors of a hand mask overlapping a document page mask of the current page, and as the hand mask moves out of the image frame, there is distortion to the page detectable from both a change in document histogram and skewness measurements.

As shown in FIG. 7, audio features module 726 inputs audio sample 714 information from the training data frame 710 and computes features such as sound levels (e.g., in dB) within predetermined frequency ranges relevant to the distinct sounds pages make when turned. In some embodiments, the audio features module 726 provides to the machine learning model 723 audio levels using either a logarithmic scale or a mel scale.

Image depth model 728 inputs depth data 716 information from the training data frame 710. As previously mentioned, the detection of a significant and/or sudden change in page depth, for example where an edge or other portion of a document page, or a hand turning a page, is detected as moving closer to the camera, is an indication that the user is tuning a page. As a page is turned, the page or the hand will often move closer to the camera. In the embodiment of FIG. 7, the image depth model 728 inputs depth data 716 together with information from the boundary detection model 722 to compute an average depth of the document page within the detected boundary box, and this average depth data provided to the machine learning model 732.

Inertial data model 730 inputs inertial data 718 information from the training data frame 710, and passes user device motion information, such as accelerometer and/or gyroscope measurement magnitudes, to the machine learning model 732 and heuristics logic 734.

For example, inertial data captures motion of the user device 102 such as when the user causes the user device 102 to move while turning a document page. Moreover, inertial data may be particularly useful to detect page turning events that do not necessarily comprise physical manipulation of a document page. For example, for scanning two-sided document pages (such as for a book laid open), event detection model 230 may infer a new page event based on detecting motion of the user device 102 shifting from left to right in combination with image data capturing motion of the user device 102 from left to right. The event detection model 230 may compute a higher confidence value for a new page event when video image data and inertial data both indicate that the user has turned to a new document page. Likewise, in some embodiments, the event detection model 230 uses a stillness of the user device 102 as indicated from the inertial data in conjunction with video image data to infer that a page capture event indication should be generated. The event detection model 230 also, in some embodiments, uses heuristics logic (shown at 234) to simplify decision-making.

In some embodiments, combinations of modules such as the page boundary detection model 722, the hand detection model 724, the audio features module 726, the image depth module 728 and/or an inertial data module 730, are used to create high-level features (such as the document masks, hand masks, IoUs, image statistics, audio samples, depth data, and/or inertial data discussed herein) that are used during the training of the machine learning model 732. It should be understood that these modules are non-limiting examples. In other embodiments, other modules detect: motion in the video stream 203, recognition of ad-hoc markers (for example, page numbers, a first few characters of the document page, and/or colors), detection of user device generated camera focus signals, detection of camera ISO number stability and/or white-balance stability.

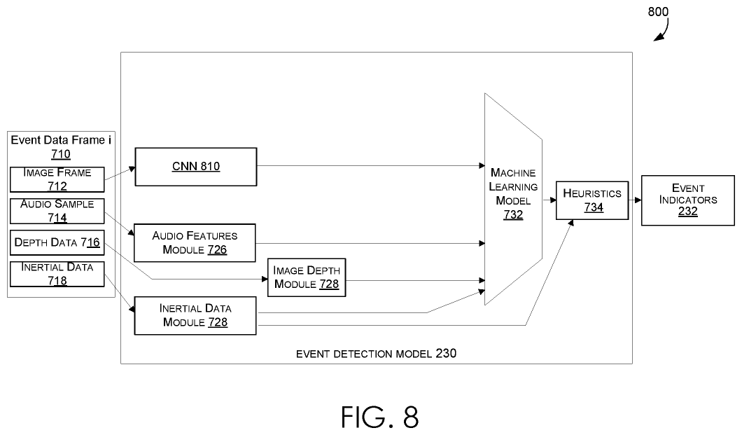

FIG. 8 is a diagram illustrating aspects of training an event detection model 230, in accordance with one embodiment. Training of the event detection model 230 as implemented by the process illustrated in FIG. 8 is equivalent to that shown in FIG. 7 with the exception that a convolutional neural network (CNN) 810 receives an image frame 712 from each data frame 710 in place of the page boundary detection model 722 and hand detection model 724. Rather than train the machine learning model 732 using the IoUs and image statistics discussed above, the CNN 810 is trained to determine what features of each image frames 712 are extracted for training and passed to the machine learning model 732. In some embodiments, the output from the CNN 810 to the machine learning model 732 comprises a vector of latent float values computed by the CNN 810 from the image frame.

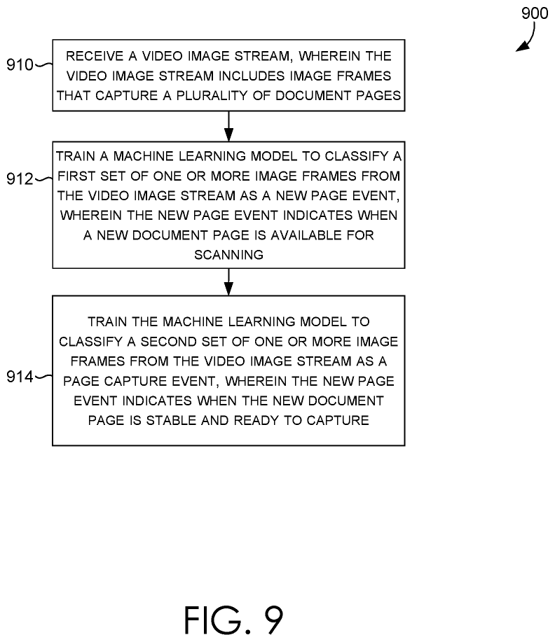

FIG. 9 comprises a flow chart illustrating a method 900 embodiment for training an event detection model for use with a multipage scanning application, for example as depicted in FIG. 1 and FIG. 2. It should be understood that the features and elements described herein with respect to the method 900 of FIG. 9 can be used in conjunction with, in combination with, or substituted for elements of, any of the other embodiments discussed herein and vice versa. Further, it should be understood that the functions, structures, and other descriptions of elements for embodiments described in FIG. 9 can apply to like or similarly named or described elements across any of the figures and/or embodiments described herein and vice versa. In some embodiments, elements of method 900 are implemented utilizing the multipage scanning environment 200 disclosed above, or other processing device implementing the present disclosure.

The method 900 includes at 910 receiving at a machine learning model a video image stream, wherein the video image stream includes image frames that capture a plurality of document pages. Each frame of the video image stream comprises one or more pages of a multipage document. In some embodiments, the video image stream is a video stream of ground truth training data images as-received from a camera or derived from a video stream as-received from a camera. In some embodiments, the video image stream comprises pre-recorded ground truth training data images received from a video streaming source, such as data store 106, for example. The method 900 includes at 912 training a machine learning model to classify a first set of one or more image frames from the video image stream as a new page event, wherein the new page event indicates when a new document page is available for scanning. The classification of an image frame as a new page event by the machine learning model is an indication that the machine learning models recognizes that a new document page of the multipage document has been placed within the field of view of the camera. For two-sided scanning, the machine learning model is trained to recognize different forms of page turning such as from image data capturing motion of the user device from left to right, or right to left.

The method 900 includes at 914 training the machine learning model to classify a second set of one or more image frames from the video image stream as a page capture event, wherein the new page event indicates when the new document page is stable and ready to capture. A page capture event generated by the machine learning model, in some embodiments, is an indication that the event detection model recognizes that the currently received frames of the video stream comprise a document page that is sufficiently clear, unobstructed, and stable for capture as a scanned page. Based on evaluation of the video stream, the machine learning model is thus trained to recognize activities that it can classify as representing new page events or page capture events, and to generate an output comprising indications of when those events are detected. In some embodiments, the machine learning model also optionally receives for training sensor data produced by one or more other device sensors, or other data derived from the sensor data (for example, such as an image histogram computed by an image statistics analyzer). In some embodiments, the machine learning model is trained to weigh each of a plurality of different data components in detecting a new page event or a page capture event, such as, but not limited to the video stream data, audio data, image depth data, inertial data, image statistics data and/or other data from other sensors of the user device. In some embodiments, the machine learning model is trained at least in part with training data produced from one or both of a document boundary detection model and a hand mask detection model, or other machine learning model that evaluates training image data and extracts features indicative of new page events and/or page capture events.

With regard to FIG. 10, one exemplary operating environment for implementing aspects of the technology described herein is shown and designated generally as computing device 1000. Computing device 1000 is just one example of a suitable computing environment and is not intended to suggest any limitation as to the scope of use or functionality of the technology described herein. Neither should the computing device 1000 be interpreted as having any dependency or requirement relating to any one or combination of components illustrated.

The technology described herein can be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein can be practiced in a variety of system configurations, including handheld devices, consumer electronics, general-purpose computers, and specialty computing devices. Aspects of the technology described herein can also be practiced in distributed computing environments where tasks are performed by remote-processing devices that are linked through a communications network.

With continued reference to FIG. 10, computing device 1000 includes a bus 1010 that directly or indirectly couples the following devices: memory 1012, one or more processors 1014, a neural network inference engine 1015, one or more presentation components 1016, input/output (I/O) ports 1018, I/O components 1020, an illustrative power supply 1022, and a radio(s) 1024. Bus 1010 represents one or more busses (such as an address bus, data bus, or combination thereof). Although the various blocks of FIG. 10 are shown with lines for the sake of clarity, it should be understood that one or more of the functions of the components can be distributed between components. For example, a presentation component 1016 such as a display device can also be considered an I/O component 1020. The diagram of FIG. 10 is merely illustrative of an exemplary computing device that can be used in connection with one or more aspects of the technology described herein. Distinction is not made between such categories as “workstation,” “server,” “laptop,” “tablet,” “smart phone” or “handheld device,” as all are contemplated within the scope of FIG. 10 and refer to “computer” or “computing device.”

Memory 1012 includes non-transient computer storage media in the form of volatile and/or nonvolatile memory. The memory 1012 can be removable, non-removable, or a combination thereof. Exemplary memory includes solid-state memory, hard drives, and optical-disc drives. Computing device 1000 includes one or more processors 1014 that read data from various entities such as bus 1010, memory 1012, or I/O components 1020. Presentation component(s) 1016 present data indications to a user or other device and in some embodiments, comprises the HMI display 252. Neural network inference engine 1015 comprises a neural network coprocessor, such as but not limited to a graphics processing unit (GPU), configured to execute a deep neural network (DNN) and/or machine learning models. In some embodiments, the event detection model 230 is implemented at least in part by the neural network inference engine 1015. Exemplary presentation components 1016 include a display device, speaker, printing component, and vibrating component. I/O port(s) 1018 allow computing device 1000 to be logically coupled to other devices including I/O components 1020, some of which can be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which can include, by way of example only, a pen or a stylus) are provided in order to digitally capture freehand user input. The connection between the pen digitizer and processor(s) 1014 can be direct or via a coupling utilizing a serial port, parallel port, and/or other interface and/or system bus known in the art. Furthermore, the digitizer input component can be a component separated from an output component such as a display device, or in some aspects, the usable input area of a digitizer can be coextensive with the display area of a display device, integrated with the display device, or can exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs can be interpreted as ink strokes for presentation in association with the computing device 1000. These requests can be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000, in some embodiments, is be equipped with depth cameras, such as stereoscopic camera systems, infrared camera systems, RGB camera systems, and combinations of these, for gesture detection and recognition. Additionally, the computing device 1000, in some embodiments, is equipped with accelerometers or gyroscopes that enable detection of motion. The output of the accelerometers or gyroscopes can be provided to the display of the computing device 1000 to render immersive augmented reality or virtual reality. A computing device, in some embodiments, includes radio(s) 1024. The radio 1024 transmits and receives radio communications. The computing device can be a wireless terminal adapted to receive communications and media over various wireless networks.

FIG. 11 is a diagram illustrating a cloud based computing environment 1100 for implementing one or more aspects of the multipage scanning environment 200 discussed with respect to any of the embodiments discussed herein. Cloud based computing environment 1100 comprises one or more controllers 1110 that each comprises one or more processors and memory, each programmed to execute code to implement at least part of the multipage scanning environment 200. In one embodiment, the one or more controllers 1110 comprise server components of a data center. The controllers 1110 are configured to establish a cloud base computing platform executing the multipage scanning environment 200. For example, in one embodiment the multipage scanning application 210 and/or the event detection model 230 are virtualized network services running on a cluster of worker nodes 1120 established on the controllers 1110. For example, the cluster of worker nodes 1120 can include one or more of Kubernetes (K8s) pods 1122 orchestrated onto the worker nodes 1120 to realize one or more containerized applications 1124 for the multipage scanning environment 200. In some embodiments, the user device 102 can be coupled to the controllers 1110 of the multipage scanning environment 200 by a network 104 (for example, a public network such as the Internet, a proprietary network, or a combination thereof). In such and embodiment, one or both of the multipage scanning application 210 and event detection model 230 are at least partially implemented by the containerized applications 1124. In some embodiments the cluster of worker nodes 1120 includes one or more one or more data store persistent volumes 1130 that implement the data store 106. In some embodiments multipage documents 250 generated by the multipage scanning application 210 are saved to the data store persistent volumes 1130 and/or ground truth data for training the event detection model 230 is received from the data store persistent volumes 1130.

In various alternative embodiments, system and/or device elements, method steps, or example implementations described throughout this disclosure (such as the multipage scanning application, event detection model, document boundary detection model, hand mask detection model, or other machine learning models, or any of the modules or sub-parts of any thereof, for example) can be implemented at least in part using one or more computer systems, field programmable gate arrays (FPGAs), application specific integrated circuits (ASICs) or similar devices comprising a processor coupled to a memory and executing code to realize that elements, processes, or examples, said code stored on a non-transient hardware data storage device. Therefore, other embodiments of the present disclosure can include elements comprising program instructions resident on computer readable media which when implemented by such computer systems, enable them to implement the embodiments described herein. As used herein, the terms “computer readable media” and “computer storage media” refer to tangible memory storage devices having non-transient physical forms and includes both volatile and nonvolatile, removable and non-removable media. Such non-transient physical forms can include computer memory devices, such as but not limited to: punch cards, magnetic disk or tape, or other magnetic storage devices, any optical data storage system, flash read only memory (ROM), non-volatile ROM, programmable ROM (PROM), erasable-programmable ROM (E-PROM), Electrically erasable programmable ROM (EEPROM), random access memory (RAM), CD-ROM, digital versatile disks (DVD), or any other form of permanent, semi-permanent, or temporary memory storage system of device having a physical, tangible form. By way of example, and not limitation, computer-readable media can comprise computer storage media and communication media. Computer storage media does not comprise a propagated data signal. Program instructions include, but are not limited to, computer executable instructions executed by computer system processors and hardware description languages such as Very High Speed Integrated Circuit (VHSIC) Hardware Description Language (VHDL).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that can be practiced. It is to be understood that other embodiments can be utilized and structural or logical changes can be made without departing from the scope of the present disclosure. Therefore, the preceding detailed description is not to be taken in the limiting sense, and the scope of embodiments is defined by the appended claims and their equivalents.

What is claimed is:

1. A system comprising:
a memory component; and
one or more processing devices coupled to the memory component, the one or more processing device to perform operations comprising:
receiving a video stream, wherein the video stream includes image frames that capture a plurality of pages of a document;
detecting, via a machine learning model trained to infer events from the video stream, a new page event, wherein the new page event indicates that a page of the plurality of pages available for scanning has changed from a first page to a second page; and
based on the detection of the new page event, capturing an image frame of the page from the video stream.

2. The system of claim 1, further comprising:
detecting, via the machine learning model, a page capture event, wherein the page capture event indicates that at least one image from the image frames comprises a stable image of the page;
wherein capturing the image frame of the page from the video stream is based on the detection of the new page event and the page capture event.

3. The system of claim 1, further comprising:
receiving sensor data from one or more sensors of a user device, wherein the machine learning model is trained to detect the new page event based on a weighted combination of the sensor data and the video stream.

4. The system of claim 3, wherein the one or more sensors comprise at least one of:
a depth sensor;
an audio sensor; or
an inertial measurement sensor.

5. The system of claim 1, wherein the new page event is determined by the machine learning model based on a plurality of frames of the video stream.

6. The system of claim 1, the method further comprising:
processing a float value vector computed by the machine learning model from at least a first image frame to detect events from a second image frame.

7. The system of claim 1, wherein the machine learning model is trained at least in part with training data produced from one or both of a document boundary detection model and a hand detection model, wherein the document boundary detection model and the hand detection model compute the training data from ground truth training data.

8. The system of claim 1, wherein the machine learning model is trained at least in part with training data comprising one or more of: audio samples, page depth data, and inertial measurement data.

9. The system of claim 1, wherein the machine learning model generates an indication of the new page event in response to detecting a turn of a page from the video stream from the first page to the second page, or detecting a change in view from the video stream from the first page to the second page.

10. A non-transitory computer-readable medium storing executable instructions, which when executed by a processing device, cause the processing device to perform operations comprising:
receiving sensor data from one or more sensors of a user device;
detecting, by a machine learning model based on the sensor data, a new page event, wherein detection of the new page event indicates that a page of the plurality of pages available for scanning has changed from a first page to a second page; and
capturing an image frame of the page from the sensor data based on the detection of the new page event.

11. The non-transitory computer-readable medium storing executable instructions of claim 10, the operations further comprising:
detecting, by the machine learning model based on the sensor data, a page capture event, wherein detection of the page capture event indicates that the sensor data comprises a stable image of the page.

12. The non-transitory computer-readable medium storing executable instructions of claim 11, wherein the new page event and the page capture event are determined by the machine learning model based on a plurality of frames of a video stream.

13. The non-transitory computer-readable medium storing executable instructions of claim 10, the operations further comprising:
processing a float value vector computed by the machine learning model from at least a first image frame from the sensor data to detect events from a second image frame of the sensor data.

14. The non-transitory computer-readable medium storing executable instructions of claim 10, wherein the machine learning model is trained at least in part with training data produced from one or both of a document boundary detection model and a hand detection model, wherein the document boundary detection model and the hand detection model compute the training data from ground truth training data.

15. The non-transitory computer-readable medium storing executable instructions of claim 10, wherein the machine learning model detects the new page event based on detecting a turn of one or more pages of the plurality of pages, or detecting of a change in view from the sensor data from a first document page to a second document page.

16. The non-transitory computer-readable medium storing executable instructions of claim 10, wherein the machine learning model detects the page capture event at least in part in based on a combination of image stream data and inertial measurements from the one or more sensors.

17. A method comprising:
receiving training dataset comprising a video stream, wherein the video stream includes image frames that capture a plurality of pages of a document; and
training a machine learning model, using the training dataset, to detect a new page event from a set of one or more image frames from the video stream, wherein the new page event indicates that a page available for scanning has changed from a first page to a second page.

18. The method of claim 17, further comprising:
training the machine learning model, using the training dataset, to detect a page capture event from the set of one or more image frames from the video stream, wherein the page capture event indicates that the video frame comprises a stable image of the page.

19. The method of claim 17, wherein the machine learning model is trained at least in part with training data produced from one or both of a document boundary detection model and a hand detection model.

20. The method of claim 17, wherein the machine learning model is further trained at least in part with training data comprising one or more of: audio samples, page depth data, and inertial measurement data.
